(19) United States
(12) Patent Application Publication
(10) Pub. No.: US 2026/0361337 A1
(43) Pub. Date: Nov. 12, 2026

(54) WIRELESS AUDIO RECEPTION DEVICE, WIRELESS AUDIO TRANSMISSION DEVICE, AND WIRELESS AUDIO OUTPUT SYSTEM COMPRISING SAME

(71) Applicant: LG ELECTRONICS INC., Seoul (KR)

(72) Inventors: Seunghyun LEE, Seoul (KR); Joonseok MAENG, Seoul (KR); Dawoon LEE, Seoul (KR)

(73) Assignee: LG ELECTRONICS INC., Seoul (KR)

(21) Appl. No.: 19/102,081

(22) PCT Filed: Aug. 8, 2022
(86) PCT No.: PCT/KR2022/011799

§ 371 Date: Feb. 7, 2025

(51) Int. Cl. H04B 1/7163; G06F 3/16

(52) U.S. Cl. CPC H04B 1/71632; G06F 3/162; H04B 2201/71636

(57) ABSTRACT

A wireless audio receiving device, a wireless audio transmitting device, and a wireless audio output system including the same are disclosed. A wireless audio transmitting device according to embodiment of the present disclosure comprises a transceiver to establish a wireless connection with a first wireless audio transmitting device and receive an audio signal from the first wireless audio transmitting device connected wirelessly through ultra-wideband communication and a sound output device to output sound corresponding to the audio signal, wherein the transceiver is configured to receive a beacon signal for each period corresponding to a first active period and a first inactive period, search for additional devices during the first inactive period, transmit a connection request command in response to a second beacon signal, and establish an additional wireless connection with the second wireless audio transmitting device. Accordingly, a plurality of communication links based on ultra-wideband communication can be established.

### BACKGROUND

### 1. Field

This disclosure relates to a wireless audio receiving device, a wireless audio transmitting device, and a wireless audio output system including the same, and more particularly, to a wireless audio receiving device, a wireless audio transmitting device, and a wireless audio output system including the same capable of configured to establish a plurality of communication links based on ultra-wideband communication.

Also, the present disclosure relates to a wireless audio receiving device, a wireless audio transmitting device, and a wireless audio output system including the same capable of stably performing an audio service based on ultra-wideband communication.

### 2. Description of the Related Art

A wireless audio receiving device wirelessly receive an audio signal from an external wireless audio transmitting device, converts the received audio signal into sound, and outputs the sound.

Meanwhile, to transmit an audio signal between a wireless audio receiving device and a wireless audio transmitting device, generation of a communication link is required.

Meanwhile, Korean Patent Publication No. 10-0772583 (hereinafter, referred to as “prior literature 1”) discloses a method and system for localization of a mobile phone using a wireless personal area network (WPAN), and a localization server and control method for the same.

According to the prior literature 1, a plurality of link generation controllers broadcast localization signals having the same information, and a link generation requesting device receives the signals and collates the received signals for localization.

However, the prior literature 1 has a drawback in that a plurality of links are not formed and only the broadcasting signal having the same information is transmitted in a unidirectional manner, making it impossible to ensure reliability through retransmission. Also, since a receiving device always has to continuously receive a broadcasting signal, the device is not allowed to enter a waiting mode, which results in significant power consumption.

Meanwhile, US Patent Publication No. U.S. Pat. No. 9,769,686 (hereinafter, referred to as “prior literature 2”) discloses a communication method and device.

According to the prior literature 2, when generating a communication link between devices, a first communication link is generated, information for connecting a second link is exchanged through the first link, and then the second communication link is generated.

However, the prior literature 2 has a drawback in that the first and second communication links are not allowed to exist at the same time and only one communication link is allowed to be formed.

### SUMMARY

The present disclosure has been made in view of the above problems and may provide a wireless audio receiving device, a wireless audio transmitting device, and a wireless audio output system including the same that may establish a plurality of communication links based on ultra-wideband communication.

The present disclosure may further provide a wireless audio receiving device, a wireless audio transmitting device, and a wireless audio output system including the same that may stably perform an audio service based on ultra-wideband communication.

The present disclosure may further provide a wireless audio receiving device, a wireless audio transmitting device, and a wireless audio output system including the same that may stably receive audio wirelessly and output sound even in complex wireless environments.

In accordance with an aspect of the present disclosure, a wireless audio receiving device and a wireless audio system including the same include a transceiver configured to establish a wireless connection with a first wireless audio transmitting device and receive an audio signal from the first wireless audio transmitting device connected wirelessly through ultra-wideband communication; and a sound output device configured to output sound corresponding to the audio signal received from the transceiver, wherein the transceiver is configured to receive a beacon signal from the first wireless audio transmitting device for each period corresponding to a first active period and a first inactive period, search for additional devices during the first inactive period, transmit a connection request command to a second wireless audio transmitting device in response to a second beacon signal being received from the second wireless audio transmitting device, and establish an additional wireless connection with the second wireless audio transmitting device based on the connection request command while being wirelessly connected with the first wireless audio transmitting device.

Meanwhile, the transceiver may be configured to receive a beacon signal for each period corresponding to the first active period from the first wireless audio transmitting device and transmit an inactive period request message or a new beacon interval request message to the first wireless audio transmitting device while being wirelessly connected with the first wireless audio transmitting device.

Meanwhile, the transceiver may be configured to transmit an inactive period request message or a new beacon interval request message to the first wireless audio transmitting device while being wirelessly connected with the first wireless audio transmitting device and, in response to a coordinator realignment command being received within a predetermine time, perform an additional device search during the first inactive period.

Meanwhile, in case in which an inactive period does not exist or the inactive period is shorter than a reference value during the period of a beacon signal received from the first wireless audio transmitting device, the transceiver may be configured to transmit an inactive period request message for configuring the inactive period or a new beacon interval request message to the first wireless audio transmitting device while being wirelessly connected with the first wireless audio transmitting device.

Meanwhile, in response to a second beacon signal being received from a second wireless audio transmitting device from an additional device search during the first inactive period, the transceiver may be configured to transmit a connection request command including information related to the period to the second wireless audio transmitting device.

Meanwhile, after establishing a wireless connection with the second wireless audio transmitting device, the transceiver may be configured to receive a second beacon signal for each period from the second wireless audio transmitting device.

Meanwhile, after the transceiver is configured to establish a wireless connection with the second wireless audio transmitting device, the period of a second beacon signal from the second wireless audio transmitting device may be adjusted to match the period of a beacon signal from the first wireless audio transmitting device.

Meanwhile, during an additional device search within the first inactive period, the period of a beacon signal received from the second wireless transmitting device may be shorter than the period corresponding to the first active period and the first inactive period.

Meanwhile, during the first inactive period, the transceiver may be configured to receive a second beacon signal from the second wireless audio transmitting device.

Meanwhile, the transceiver may be configured to receive the second beacon signal for each period including a second active period and a second inactive period.

Meanwhile, the sound output device may be configured to output a first sound based on a first audio signal from the first wireless audio transmitting device while being wirelessly connected with the first wireless audio transmitting device and output a first sound based on a first audio signal from the first wireless audio transmitting device and a second sound based on a second audio signal from the second wireless audio transmitting device together while being wirelessly connected with the second wireless audio transmitting device.

In accordance with another aspect of the present disclosure, a wireless audio receiving device and a wireless audio system including the same include a transceiver configured to wirelessly connect to a first wireless audio transmitting device and receive an audio signal from the first wireless audio transmitting device connected wirelessly through ultra-wideband communication; and a sound output device configured to output sound corresponding to the audio signal received from the transceiver, wherein the transceiver is configured to establish an additional wireless connection with a second wireless audio transmitting device while performing an additional wireless connection with the first wireless audio transmitting device, and the period of a beacon signal from the first wireless audio transmitting device performing a wireless connection with the first wireless audio transmitting device and the second wireless audio transmitting device is greater than the period of a beacon signal from the first wireless audio transmitting device performing a wireless connection with the first wireless audio transmitting device.

Meanwhile, the transceiver may be configured to receive a beacon signal for each period corresponding to the first active period from the first wireless audio transmitting device while being wirelessly connected with the first wireless audio transmitting device and receive a beacon signal from the first wireless audio transmitting device for each period corresponding to the first active period and the first inactive period while being wirelessly connected with the first wireless audio transmitting device and the second wireless audio transmitting device.

Meanwhile, the transceiver may be configured to receive a beacon signal from the second wireless audio transmitting device for each period corresponding to the first active period and the first inactive period while being wirelessly connected with the first wireless audio transmitting device and the second wireless audio transmitting device.

In accordance with an aspect of the present disclosure, a wireless audio transmitting device and a wireless audio system including the same include a transceiver configured to establish a wireless connection with a wireless audio receiving device and transmit an audio signal to the wireless audio receiving device connected wirelessly through ultra-wideband communication, wherein the transceiver is configured to transmit a beacon signal for each period corresponding to the first active period, receive an inactive period request message or a new beacon interval request message from the wireless audio receiving device while being wirelessly connected with the wireless audio receiving device, and is configured to transmit a beacon signal for each period corresponding to the first active period and the first inactive period in response to the inactive period request message or the new beacon interval request message.

Meanwhile, the transceiver may be configured to transmit a coordinator realignment command in response to the inactive period request message or the new beacon interval request message and transmit a beacon signal for each period corresponding to the first active period and the first inactive period after transmitting the coordinator realignment command.

### EFFECTS OF THE DISCLOSURE

In accordance with an aspect of the present disclosure, a wireless audio receiving device and a wireless audio system including the same include a transceiver configured to establish a wireless connection with a first wireless audio transmitting device and receive an audio signal from the first wireless audio transmitting device connected wirelessly through ultra-wideband communication; and a sound output device configured to output sound corresponding to the audio signal received from the transceiver, wherein the transceiver is configured to receive a beacon signal from the first wireless audio transmitting device for each period corresponding to a first active period and a first inactive period, search for additional devices during the first inactive period, transmit a connection request command to a second wireless audio transmitting device in response to a second beacon signal being received from the second wireless audio transmitting device, and establish an additional wireless connection with the second wireless audio transmitting device based on the connection request command while being wirelessly connected with the first wireless audio transmitting device. Accordingly, a plurality of communication links based on ultra-wideband communication can be established.

Meanwhile, the transceiver may be configured to receive a beacon signal for each period corresponding to the first active period from the first wireless audio transmitting device and transmit an inactive period request message or a new beacon interval request message to the first wireless audio transmitting device while being wirelessly connected with the first wireless audio transmitting device. Accordingly, a beacon signal may be received for each period corresponding to the first active period and the first inactive period.

Meanwhile, the transceiver may be configured to transmit an inactive period request message or a new beacon interval request message to the first wireless audio transmitting device while being wirelessly connected with the first wireless audio transmitting device and, in response to a coordinator realignment command being received within a predetermine time, perform an additional device search during the first inactive period. Accordingly, a plurality of communication links based on ultra-wideband communication can be established.

Meanwhile, in case in which an inactive period does not exist or the inactive period is shorter than a reference value during the period of a beacon signal received from the first wireless audio transmitting device, the transceiver may be configured to transmit an inactive period request message for configuring the inactive period or a new beacon interval request message to the first wireless audio transmitting device while being wirelessly connected with the first wireless audio transmitting device. Accordingly, a beacon signal may be received for each period corresponding to the first active period and the first inactive period.

Meanwhile, in response to a second beacon signal being received from a second wireless audio transmitting device from an additional device search during the first inactive period, the transceiver may be configured to transmit a connection request command including information related to the period to the second wireless audio transmitting device. Accordingly, the second beacon signal synchronized with the beacon signal from the first wireless audio transmitting device may be received.

Meanwhile, after establishing a wireless connection with the second wireless audio transmitting device, the transceiver may be configured to receive a second beacon signal for each period from the second wireless audio transmitting device. Accordingly, the second beacon signal synchronized with the beacon signal from the first wireless audio transmitting device may be received.

Meanwhile, after the transceiver is configured to establish a wireless connection with the second wireless audio transmitting device, the period of a second beacon signal from the second wireless audio transmitting device may be adjusted to match the period of a beacon signal from the first wireless audio transmitting device. Accordingly, the second beacon signal synchronized with the beacon signal from the first wireless audio transmitting device may be received.

Meanwhile, during an additional device search within the first inactive period, the period of a beacon signal received from the second wireless transmitting device may be shorter than the period corresponding to the first active period and the first inactive period. Accordingly, after being wirelessly connected with the second wireless audio transmitting device, the second beacon signal synchronized with the beacon signal from the first wireless audio transmitting device may be received.

Meanwhile, during the first inactive period, the transceiver may be configured to receive a second beacon signal from the second wireless audio transmitting device. Accordingly, the second beacon signal synchronized with the beacon signal from the first wireless audio transmitting device may be received.

Meanwhile, the transceiver may be configured to receive the second beacon signal for each period including a second active period and a second inactive period. Accordingly, the second beacon signal synchronized with the beacon signal from the first wireless audio transmitting device may be received.

Meanwhile, the sound output device may be configured to output a first sound based on a first audio signal from the first wireless audio transmitting device while being wirelessly connected with the first wireless audio transmitting device and output a first sound based on a first audio signal from the first wireless audio transmitting device and a second sound based on a second audio signal from the second wireless audio transmitting device together while being wirelessly connected with the second wireless audio transmitting device. Accordingly, an audio service based on ultra-wideband communication may be performed stably. Also, sound may be output by receiving a wireless audio signal reliably even in complex wireless environments. In particular, a plurality of communication links based on ultra-wideband communication can be established to produce a plurality of sounds together.

In accordance with another aspect of the present disclosure, a wireless audio receiving device and a wireless audio system including the same include a transceiver configured to wirelessly connect to a first wireless audio transmitting device and receive an audio signal from the first wireless audio transmitting device connected wirelessly through ultra-wideband communication; and a sound output device configured to output sound corresponding to the audio signal received from the transceiver, wherein the transceiver is configured to establish an additional wireless connection with a second wireless audio transmitting device while performing an additional wireless connection with the first wireless audio transmitting device, and the period of a beacon signal from the first wireless audio transmitting device performing a wireless connection with the first wireless audio transmitting device and the second wireless audio transmitting device is greater than the period of a beacon signal from the first wireless audio transmitting device performing a wireless connection with the first wireless audio transmitting device. Accordingly, a plurality of communication links based on ultra-wideband can be established.

Meanwhile, the transceiver may be configured to receive a beacon signal for each period corresponding to the first active period from the first wireless audio transmitting device while being wirelessly connected with the first wireless audio transmitting device and receive a beacon signal from the first wireless audio transmitting device for each period corresponding to the first active period and the first inactive period while being wirelessly connected with the first wireless audio transmitting device and the second wireless audio transmitting device. Accordingly, the second beacon signal synchronized with the beacon signal from the first wireless audio transmitting device may be received.

Meanwhile, the transceiver may be configured to receive a beacon signal from the second wireless audio transmitting device for each period corresponding to the first active period and the first inactive period while being wirelessly connected with the first wireless audio transmitting device and the second wireless audio transmitting device. Accordingly, the second beacon signal synchronized with the beacon signal from the first wireless audio transmitting device may be received.

In accordance with an aspect of the present disclosure, a wireless audio transmitting device and a wireless audio system including the same include a transceiver configured to establish a wireless connection with a wireless audio receiving device and transmit an audio signal to the wireless audio receiving device connected wirelessly through ultra-wideband communication, wherein the transceiver is configured to transmit a beacon signal for each period corresponding to the first active period, receive an inactive period request message or a new beacon interval request message from the wireless audio receiving device while being wirelessly connected with the wireless audio receiving device, and is configured to transmit a beacon signal for each period corresponding to the first active period and the first inactive period in response to the inactive period request message or the new beacon interval request message. Accordingly, a plurality of communication links based on ultra-wideband can be established.

Meanwhile, the transceiver may be configured to transmit a coordinator realignment command in response to the inactive period request message or the new beacon interval request message and transmit a beacon signal for each period corresponding to the first active period and the first inactive period after transmitting the coordinator realignment command. Accordingly, a plurality of communication links based on ultra-wideband can be established.

### BRIEF DESCRIPTION OF THE DRAWINGS

FIGS. 1A to 1E are diagrams illustrating a wireless audio system including a wireless audio receiving device and a wireless audio transmitting device according to various embodiments of the present disclosure;

FIG. 2 is an example of an internal block diagram of the wireless audio receiving device of FIGS. 1A to 1E;

FIGS. 3A to 8B are diagrams for explaining an operation of a wireless audio receiving device or a wireless audio transmitting device according to an embodiment of the present disclosure;

FIG. 9 is an example of a flowchart showing a method of operating a wireless audio output system according to an embodiment of the present disclosure;

FIGS. 10 to 13B are diagrams referred to in description of FIG. 9.

### DETAILED DESCRIPTION OF THE PREFERRED EMBODIMENTS

Hereinafter, the present disclosure will be described in more detail with reference to the drawings.

The suffixes such as “module” and “unit” may be used to refer to elements or components. Use of such suffixes herein is merely intended to facilitate description of the specification, and the suffixes do not have any special meaning or function. Accordingly, the “module” and “unit” may be used interchangeably.

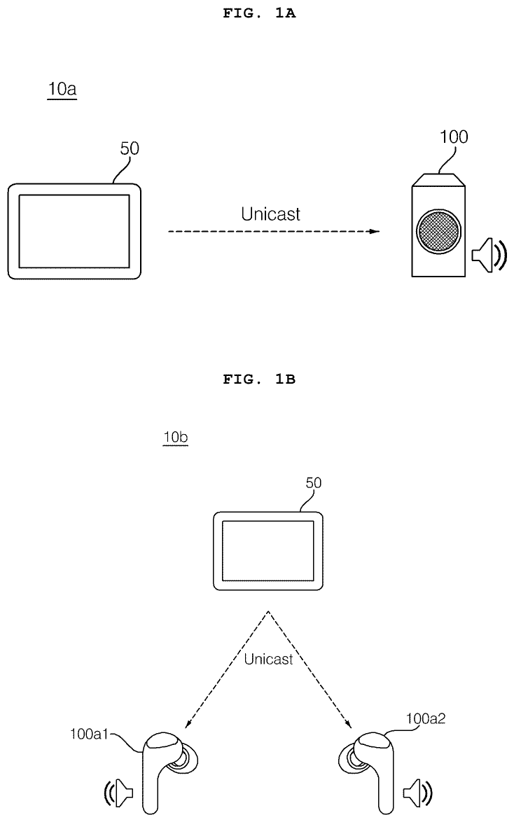

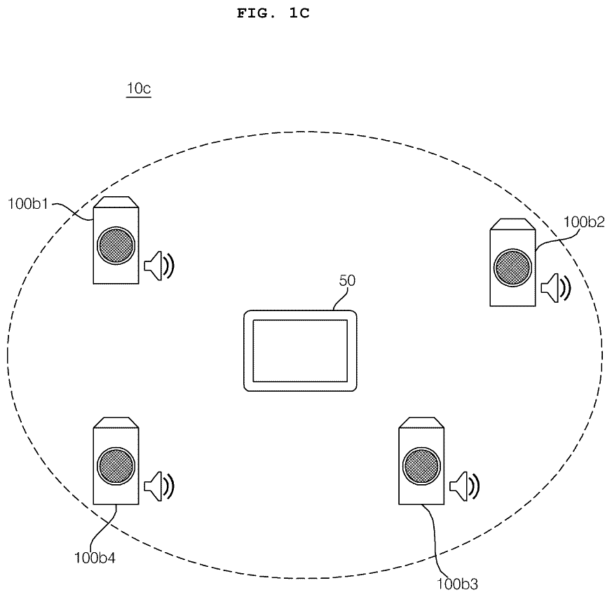

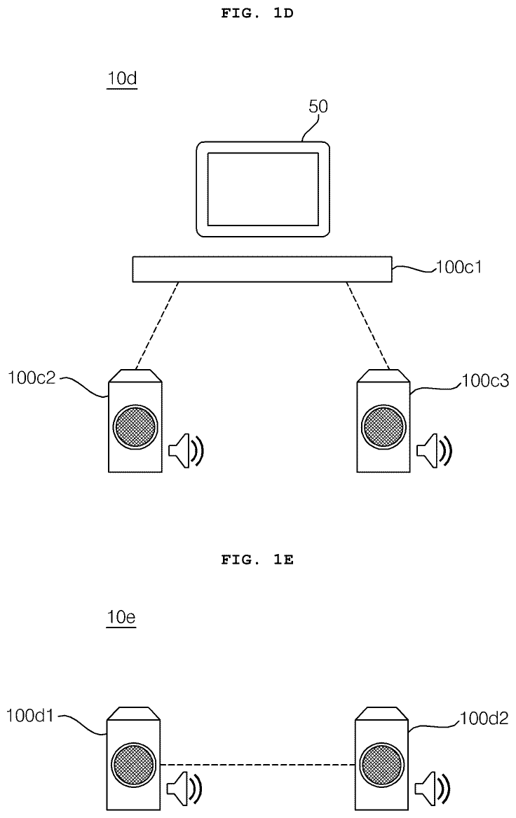

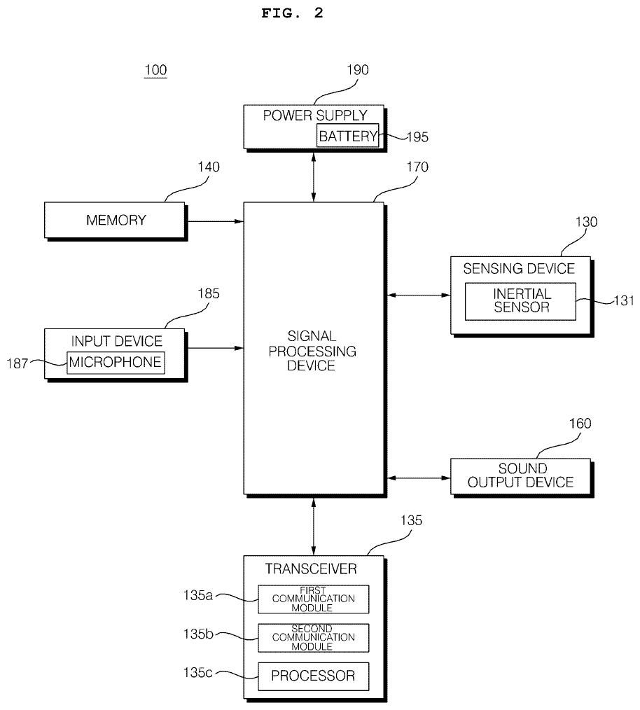

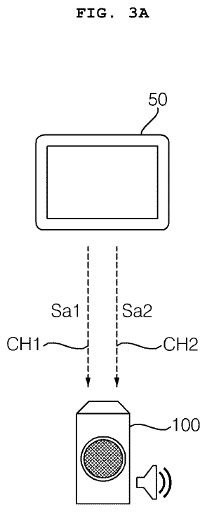

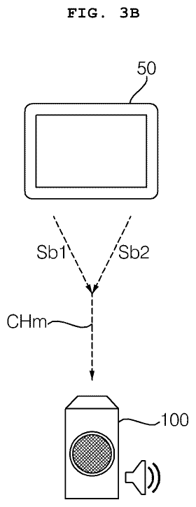

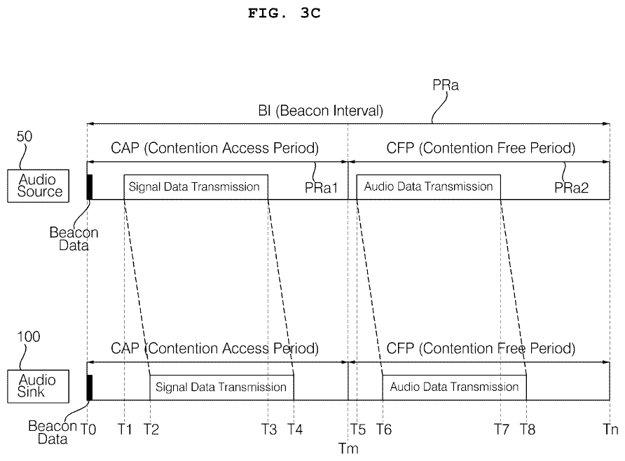

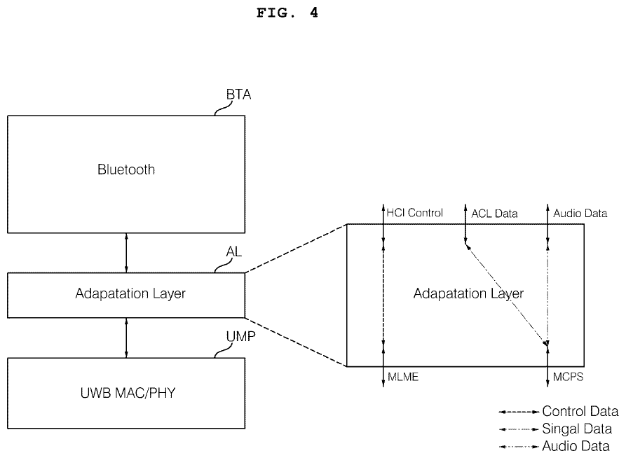

FIGS. 1A to 1E are diagrams illustrating a wireless audio system including a wireless audio receiving device and a wireless audio transmitting device according to various embodiments of the present disclosure.

First, FIG. 1A illustrates a wireless audio system 10a according to an embodiment of the present disclosure.

Referring to FIG. 1A, the wireless audio system 10a according to an embodiment of the present disclosure may include a wireless audio transmitting device 50 and a wireless audio receiving device 100.

In particular, in the wireless audio system 10a, the wireless audio transmitting device 50 and the wireless audio receiving device 100 may correspond one-to-one, based on a unicast method.

The wireless audio transmitting device 50 may include a first communication module 135a wirelessly transmitting a first audio signal based on a first communication standard of a first frequency band, and a second communication module 135b wirelessly transmitting a second audio signal based on a second communication standard of a second frequency band greater than the first frequency band.

Meanwhile, the wireless audio receiving device 100 may include a first communication module 135a wirelessly receiving a first audio signal according to the first communication standard of a first frequency band, and a second communication module 135b wirelessly receiving a second audio signal according to the second communication standard of a second frequency band greater than the first frequency band.

For example, if the wireless environment becomes complex and the packet error rate of the first audio signal exceeds a predetermined threshold while configured to output a first sound based on a first audio signal wirelessly received through the first communication module 135a according to the first communication standard of a first frequency band, the wireless audio receiving device 100 may be configured to output a second sound based on a second audio signal wirelessly received through the second communication module 135b according to the second communication standard of a second frequency band.

Accordingly, even though the wireless environment is complex, it is possible to stably receive audio wirelessly and output sound.

Meanwhile, the wireless audio receiving device 100 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Therefore, a plurality of communication links based on ultra-wideband communication can be established.

Next, FIG. 1B illustrates a wireless audio system 10b according to another embodiment of the present disclosure.

Referring to FIG. 1B, the wireless audio system 10b according to another embodiment of the present disclosure may include a wireless audio transmitting device 50 and a plurality of wireless audio receiving devices 100a1 and 100a2.

In particular, the wireless audio system 10b may include a wireless audio transmitting device 50 and a plurality of wireless audio receiving devices 100a1 and 100a2, based on a unicast method.

For example, when wireless audio signals of a first channel to a second channel are output from the wireless audio transmitting device 50, a wireless audio signal of the first channel may be transmitted to a first wireless audio receiving device 100a1 among a plurality of wireless audio receiving devices 100a1 and 100a2, and a wireless audio signal of the second channel may be transmitted to a second wireless audio receiving device 100a2. Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100a1, 100a2 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100a1, 100a2 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Therefore, a plurality of communication links based on ultra-wideband communication can be established.

At this time, the plurality of wireless audio receiving devices 100a1 and 100a2 may be left and right wireless audio receiving devices, respectively.

Next, FIG. 1C illustrates a wireless audio system 10c according to another embodiment of the present disclosure.

Referring to FIG. 1C, a wireless audio system 10c according to another embodiment of the present disclosure may include a wireless audio transmitting device 50 and a plurality of wireless audio receiving devices 100b1 to 100b4.

In particular, the wireless audio system 10c may include a wireless audio transmitting device 50 and a plurality of wireless audio receiving devices 100b1 to 100b4, based on a broadcast method.

For example, when wireless audio signals of first to fourth channels are output from the wireless audio transmitting device 50, a wireless audio signal of a first channel may be transmitted to a first wireless audio receiving device 100b1 among a plurality of wireless audio receiving devices 100b1 to 100b4, a wireless audio signal of a second channel may be transmitted to a second wireless audio receiving device 100b2, a wireless audio signal of a third channel may be transmitted to a third wireless audio receiving device 100b3, and a wireless audio signal of a fourth channel may be transmitted to a fourth wireless audio receiving device 100b4. Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100b1-100b4 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100b1-100b4 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Therefore, a plurality of communication links based on ultra-wideband communication can be established.

Next, FIG. 1D illustrates a wireless audio system 10d according to another embodiment of the present disclosure.

Referring to FIG. 1D, the wireless audio system 10d according to another embodiment of the present disclosure may include a wireless audio transmitting device 50 and a plurality of wireless audio receiving devices 100c1 to 100c3.

In particular, the wireless audio system 10d may include a wireless audio transmitting device 50 and a plurality of wireless audio receiving devices 100c1 to 100c3, based on a unicast method.

For example, when wireless audio signals of first to third channels are output from the wireless audio transmitting device 50, a wireless audio signal of a first channel may be transmitted to a first wireless audio receiving device 100c1 among a plurality of wireless audio receiving devices 100c1 to 100c3, a wireless audio signal of a second channel may be transmitted to a second wireless audio receiving device 100c2, and a wireless audio signal of a third channel may be transmitted to a third wireless audio receiving device 100c3.

As another example, when wireless audio signals of first to third channels are output from the wireless audio transmitting device 50, wireless audio signals of a first channel to a third channel may be transmitted to a first wireless audio receiving device 100c1 among a plurality of wireless audio receiving devices 100c1 to 100c3, the first wireless audio receiving device 100c1 may be configured to output wireless audio signals of second to third channels, a wireless audio signal of the second channel may be transmitted to a second wireless audio receiving device 100c2, and a wireless audio signal of the third channel may be transmitted to a third wireless audio receiving device 100c3.

Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100c1-100c3 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100c1-100c3 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Therefore, a plurality of communication links based on ultra-wideband communication can be established.

Next, FIG. 1E illustrates a wireless audio system 10e according to another embodiment of the present disclosure.

Referring to FIG. 1E, a wireless audio system 10e according to another embodiment of the present disclosure may include a plurality of wireless audio receiving devices 100d1 and 100d2.

In particular, the wireless audio system 10e may include a plurality of wireless audio receiving devices 100d1 and 100d2, based on a unicast method.

For example, when a wireless audio signal is output from the first wireless audio receiving device 100d1, the wireless audio signal may be transmitted to the second wireless audio receiving device 100d2.

Accordingly, even though the wireless environment is complex, it is possible to stably receive audio wirelessly and output sound.

Meanwhile, if the wireless environment becomes complex and the packet error rate of the first audio signal exceeds a predetermined threshold while configured to output a first sound based on a first audio signal wirelessly received through the first communication module 135a according to the first communication standard of the first frequency band, each of the wireless audio receiving devices 100d1, 100d2 may be configured to output a second sound based on a second audio signal wirelessly received through the second communication module 135b according to the second communication standard of the second frequency band. Accordingly, even though the wireless environment is complex, it is possible to stably receive audio wirelessly and output sound.

Meanwhile, each of the wireless audio receiving devices 100d1, 100d2 may be configured to receive a beacon signal from the first wireless audio transmitting device 50a for each period P_{c} corresponding to the first active period Pₐ and the first inactive period P_{b}, transmit a connection request command to the second wireless audio transmitting device 50b if a second beacon signal from the second wireless audio transmitting device 50b is received during the first inactive period P_{b} while searching for additional devices, and, based on the connection request command, establish an additional wireless connection with the second wireless audio transmitting device 50b based on ultra-wideband communication while being wirelessly connected with the first wireless audio transmitting device 50a. Therefore, a plurality of communication links based on ultra-wideband communication can be established.

Meanwhile, the wireless audio transmitting device 50 illustrated in FIGS. 1A to 1E may be a mobile terminal, a TV, a monitor, a tablet, a home appliance, a vehicle display device, and the like.

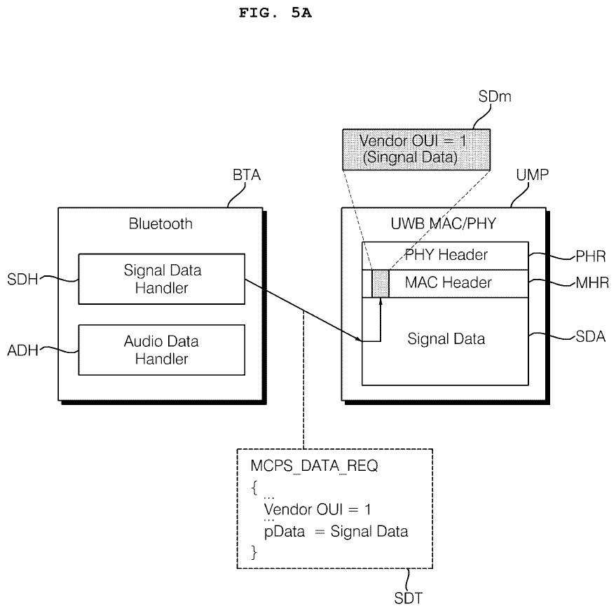

FIG. 2 is an example of an internal block diagram of the wireless audio receiving device of FIGS. 1A to 1E.

Referring to FIG. 2, the wireless audio receiving device 100 may include a sensing device 130, a transceiver 135, a memory 140, a sound output device 160, a signal processing device 170, an input device 185, and a power supply 190. When these components are implemented in actual applications, if necessary, two or more components may be combined into one component, or one component may be subdivided into two or more components.

The sensing device 130 may include an inertial sensor 131. The inertial sensor may include an acceleration sensor, a gyro sensor, a gravity sensor, or the like. For example, the acceleration sensor, the gyro sensor, the gravity sensor, or the like may include a 6-axis sensor.

The sensing device 130 may be configured to output motion information of the wireless audio receiving device 100, for example, movement information (acceleration information, angular velocity information) or location information based on x, y, z axis.

Meanwhile, the sensing device 130 may include a sensor for obtaining user body information. For example, a blood pressure sensor, a brain wave sensor, or the like may be provided.

Meanwhile, the transceiver 135 may provide an interface for communication with an external device. To this end, the transceiver 135 may include at least one of a mobile communication module (not shown), a wireless Internet module (not shown), a short-distance communication module (not shown), or a GPS module (not shown).

For example, the transceiver 135 may perform IR communication, Bluetooth communication, or WiFi communication, thereby exchanging data with a paired wireless audio transmitting device 50 or transmitting data. In particular, it may be configured to receive an audio signal from the paired wireless audio transmitting device 50.

Meanwhile, the transceiver 135 may include a first communication module 135a that wirelessly receives a first audio signal according to the first communication standard of a first frequency band, and a second communication module 135b that wirelessly receives a second audio signal according to the second communication standard of a second frequency band greater than the first frequency band.

Meanwhile, the transceiver 135 may further include a processor 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, even though the wireless environment is complex, it is possible to stably receive audio wirelessly and output sound. In addition, signal data and audio data can be distinguished in the first communication module 135a and the second communication module 135b, so that audio can be stably received wirelessly and sound can be output.

Meanwhile, the beacon message received by the second communication module 135b may include unicast information or broadcast information. Accordingly, it is possible to operate by dividing into unicast and broadcast.

Meanwhile, in response to unicast information being included in the received beacon message, the second communication module 135b may be configured to transmit association request information to the wireless audio transmitting device 50 or 100, and may be configured to receive association response information from the wireless audio transmitting device 50 or 100. Accordingly, it is possible to operate by dividing into unicast and broadcast.

Meanwhile, the second communication module 135b may distinguish whether it is the second signal data or the second audio data, based on identification information in the header among the received second audio signal. Accordingly, signal data and audio data can be distinguished, thereby stably receiving audio wirelessly and configured to output sound.

Meanwhile, the second communication module 135b may distinguish whether it is the second signal data or the second audio data, based on identification information in a media access control (MAC) header or a physical (PHY) header among the received second audio signal. Accordingly, signal data and audio data can be distinguished, thereby stably receiving audio wirelessly and configured to output sound.

Meanwhile, in response to receiving the second signal data, the second communication module 135b may extract encoding or decoding information of the second standard, and based on the extracted encoding or decoding information, may be configured to receive the second audio data after the second signal data, and may set a replay time of the second audio data. Accordingly, signal data and audio data can be distinguished, thereby stably receiving audio wirelessly and configured to output sound.

The memory 140 may store programs for processing or controlling the signal processing device 170 in the wireless audio receiving device 100, or may perform a function for temporarily storing input or output data.

The sound output device 160 may be configured to output an audio signal processed by the signal processing device 170 in the wireless audio receiving device 100.

Alternatively, the sound output device 160 may be configured to output guide information related to the operation of the wireless audio receiving device 100 as an audio signal.

Meanwhile, the sound output device 160 may be configured to output a first sound corresponding to the first audio signal from the first communication module 135a or a second sound corresponding to the second audio signal from the second communication module 135b.

The signal processing device 170 may control the overall operation of the wireless audio receiving device 100 by controlling the operation of each unit in the wireless audio receiving device 100.

Meanwhile, the signal processing device 170 may perform signal processing for an audio signal received from the outside.

Meanwhile, the signal processing device 170 may replay an audio signal from the first communication module 135a or the second communication module 135b.

Meanwhile, the signal processing device 170 may replay the second audio data, based on the decoding information from the second communication module 135b and a set replay time. Accordingly, signal data and audio data can be distinguished, thereby stably receiving audio wirelessly and configured to output sound.

Meanwhile, the input device 185 may include a button for initializing the wireless audio receiving device 100, or inputting an operation.

Meanwhile, the input device 185 may include a microphone 187 for sound collection.

Meanwhile, the input device 185 may include a camera (not shown) for capturing images.

For example, as shown in FIG. 2, the input device 185 may include, in the drawing, a power key 185a for turning power on or off, a FF/REW key 185b for going forward or backward in the reproducing audio, a volume key 185c for volume up or down, a pause/play key 185d for playing or pausing audio, and the like.

The power supply 190 may supply power required for operation of each component under the control of the signal processing device 170.

In particular, the power supply 190 may include a battery 195 that stores and outputs DC power.

FIGS. 3A to 8B are diagrams for explaining an operation of a wireless audio receiving device or a wireless audio transmitting device according to an embodiment of the present disclosure.

FIG. 3A illustrates that the wireless audio transmitting device 50 output a first signal data Sal and a first audio data Sa2 to the wireless audio receiving device 100.

Referring to FIG. 3A, the wireless audio transmitting device 50 wirelessly outputs the first signal data Sal and the first audio data Sa2 according to the first communication standard of a first frequency band.

In particular, the wireless audio transmitting device 50 may be configured to transmit the first signal data Sal through the first channel CH1, and separately transmit the first audio data Sa2 through the second channel CH2.

Accordingly, the first communication module 135a in the wireless audio receiving device 100 according to an embodiment of the present disclosure receives the first signal data Sal through the first channel CH1, and distinguishes and receives the first audio data Sa2 through the second channel CH2.

FIG. 3B illustrates that the wireless audio transmitting device 50 outputs the second signal data Sb1 and the second audio data Sb2 to the wireless audio receiving device 100.

Referring to FIG. 3B, the wireless audio transmitting device 50 wirelessly outputs the second signal data Sb1 and the second audio data Sb2 according to the second communication standard of a second frequency band greater than the first frequency band.

In particular, the wireless audio transmitting device 50 may separately transmit the second signal data Sb1 and the second audio data Sb2 through the same channel CHm.

Accordingly, the second communication module 135b in the wireless audio receiving device 100 according to an embodiment of the present disclosure separately receives the second signal data Sb1 and the second audio data Sb2 through the same channel CHm.

Meanwhile, the first communication standard may be a Bluetooth communication standard, and the second communication standard may be an ultra-wideband (UWB) communication standard.

For example, the wireless audio transmitting device 50 may wirelessly transmit an audio signal according to the first communication standard, and then wirelessly transmit the audio signal according to the second communication standard when the wireless environment is complex.

Accordingly, the wireless audio receiving device 100 may stably receive audio wirelessly and output sound even though the wireless environment is complex. In addition, signal data and audio data can be distinguished in the first communication module 135a and the second communication module 135b, so that audio can be stably received wirelessly and sound can be output.

Meanwhile, according to an embodiment of the present disclosure, the first communication module 135a may separately transmit first signal data Sal through the first channel CH1 and first audio data Sa2 through the second channel CH2, and the second communication module 135b may be configured to transmit second signal data Sb1 and second audio data Sb2 separately through the same channel CHm. Accordingly, even though the wireless environment is complex, it is possible to stably receive audio wirelessly and output sound. Also, signal data and audio data may be transmitted separately.

Meanwhile, the beacon message transmitted from the second communication module 135b in the wireless audio transmitting device 50 may include unicast information or broadcast information. Accordingly, it is possible to operate by dividing into unicast and broadcast.

Meanwhile, in response to unicast information being included in the transmitted beacon message, the second communication module 135b within the wireless audio transmitting device 50 may be configured to receive association request information from the wireless audio receiving device 100 and may be configured to transmit association response information from an electronic device to the wireless audio receiving device 100. Accordingly, it is possible to operate by dividing into unicast and broadcast. Also, the second communication module 135b may check whether ultra-wideband (UWB) wireless audio support is available and transmit audio data wirelessly.

Meanwhile, the second communication module 135b in the wireless audio transmitting device 50 may add identification information in a media access control (MAC) header or a physical (PHY) header in order to distinguish whether the transmitted second audio signal is the second signal data Sb1 or the second audio data Sb2. Accordingly, it is possible to operate by dividing into unicast and broadcast.

Meanwhile, when the first communication module 135a in the wireless audio transmitting device 50 is configured to transmit the first audio signal and then the second communication module 135b is configured to transmit the second audio signal, Host Control Interface (HCl) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard. Accordingly, signal data and audio data can be distinguished, thereby stably transmitting audio wirelessly.

Meanwhile, when the first communication module 135a in the wireless audio transmitting device 50 is configured to transmit the first audio signal and then the second communication module 135b is configured to transmit the second audio signal, an adaptation layer (AL) may be used to map data of the first communication standard to data of the second communication standard. Accordingly, signal data and audio data can be distinguished, thereby stably transmitting audio wirelessly.

Meanwhile, when the second communication module 135b in the wireless audio transmitting device 50 is configured to transmit the second audio signal, it may be configured to transmit the second signal data Sb1 in a contention access period (CAP) of the beacon interval PRa, and may be configured to transmit the second audio data Sb2 in a contention free period (CFP) of the beacon interval PRa. Accordingly, signal data and audio data can be distinguished, thereby stably transmitting audio wirelessly.

Meanwhile, the first communication module 135a in the wireless audio transmitting device 50 may be configured to transmit the first signal data Sal and transmit identification information in the first signal data Sal to the second communication module 135b, and the second communication module 135b may separately transmit the second signal data Sb1 in the second audio signal, based on the identification information from the first communication module 135a. Accordingly, signal data and audio data can be distinguished, thereby stably transmitting audio wirelessly.

Meanwhile, the first communication module 135a in the wireless audio transmitting device 50 may be configured to transmit the first audio data Sa2 and transmit identification information in the first audio data Sa2 to the second communication module 135b, and the second communication module 135b may separately transmit the second audio data Sb2 in the second audio signal, based on the identification information from the first communication module 135a. Accordingly, signal data and audio data can be distinguished, thereby stably transmitting audio wirelessly.

Meanwhile, the second communication module 135b in the wireless audio transmitting device 50 may be configured to receive a security activation value from the wireless audio receiving device 100, and if it matches, generate a key, and encrypt and transmit the second audio data Sb2 by using the generated key. Accordingly, it is possible to stably transmit audio wirelessly based on security.

FIG. 3C is a diagram for explaining the operation of the wireless audio transmitting device 50 and the first communication module 135a of the wireless audio receiving device 100.

Referring to FIG. 3, the wireless audio transmitting device 50 may wirelessly transmit beacon data at time To during the beacon interval PRa, and the wireless audio receiving device 100 may wirelessly receive the beacon data.

Meanwhile, the wireless audio transmitting device 50 may be configured to transmit signal data in a contention access period (CAP) of the beacon interval PRa, and transmit audio data in a contention free period (CFP) of the beacon interval PRa.

In particular, FIG. 3 illustrates that signal data is transmitted between time T1 and time T3 within a contention access period (CAP), and audio data is transmitted between time T5 and time T7 within a contention free period (CFP).

In response, the wireless audio receiving device 100 may be configured to receive signal data between time T2 and time T4 within a contention access period (CAP), and may be configured to receive audio data between time T6 and time T8 within a contention free period (CFP).

That is, when the second communication module 135b in the wireless audio receiving device 100 receives the second audio signal, it may be configured to receive the second signal data Sb1 in the contention access period (CAP) of the beacon interval PRa, and may be configured to receive the second audio data Sb2 in the contention free period (CFP) of the beacon interval PRa. Accordingly, signal data and audio data can be distinguished, thereby stably receiving audio wirelessly and configured to output sound.

FIG. 4 is a diagram for explaining mapping between the first communication standard and the second communication standard.

Referring to FIG. 4, in order to provide a UWB audio service which is an example of the second communication standard, Bluetooth audio, which is an example of the first communication standard optimized for the audio service, is adopted as an upper protocol.

Bluetooth audio (BTA) interface is composed of HCl Control, ACL Data, and Audio Data.

Meanwhile, the Media access control or physical layer (MAC/PHY) (UMP) of UWB may have a MAC Layer Management Entity (MLME) interface and a MAC Common Part Sublayer (MCPS) interface.

Meanwhile, for mapping between Bluetooth audio (BTA) and UWB media access control or a physical layer (MAC/PHY) (UMP), an adaptation layer (AL) is utilized in an embodiment of the present disclosure.

In the adaptation layer (AL), Host Control Interface (HCl) data of the first communication standard may be mapped to MAC Layer Management Entity (MLME) interface of the second communication standard, and Asynchronous Connection-Less (ACL) data and audio data of the first communication standard may be mapped to a MAC Common Part Sublayer (MCPS) interface of the second communication standard.

Meanwhile, UWB wireless transmission or UWB wireless reception has a frequency band 3.1 GHz to 10.6 GHz different from the unlicensed band 2.4 GHz, thereby avoiding frequency interference with other wireless devices using the unlicensed band, and solving problems such as audio interruption.

In addition, since UWB wireless transmission or UWB wireless reception provides a higher PHY data rate than Bluetooth wireless transmission or wireless reception, high-quality audio service is possible.

Meanwhile, when the first communication module 135a receives the first audio signal and then the second communication module 135b receives the second audio signal, Host Control Interface (HCl) data of the first communication standard may be mapped to the MAC Layer Management Entity (MLME) interface of the second communication standard, and Asynchronous Connection-Less (ACL) data and audio data of the first communication standard may be mapped to the MAC Common Part Sublayer (MCPS) interface of the second communication standard. Accordingly, signal data and audio data can be distinguished, thereby stably receiving audio wirelessly and configured to output sound.

Meanwhile, when the first communication module 135a receives the first audio signal and then the second communication module 135b receives the second audio signal, data of the first communication standard may be mapped to data of the second communication standard by using an adaptation layer AL. Accordingly, signal data and audio data can be distinguished, thereby stably receiving audio wirelessly and configured to output sound.

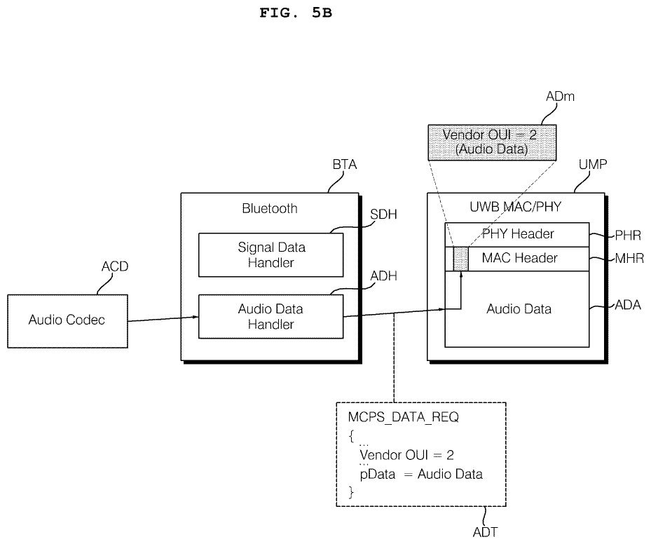

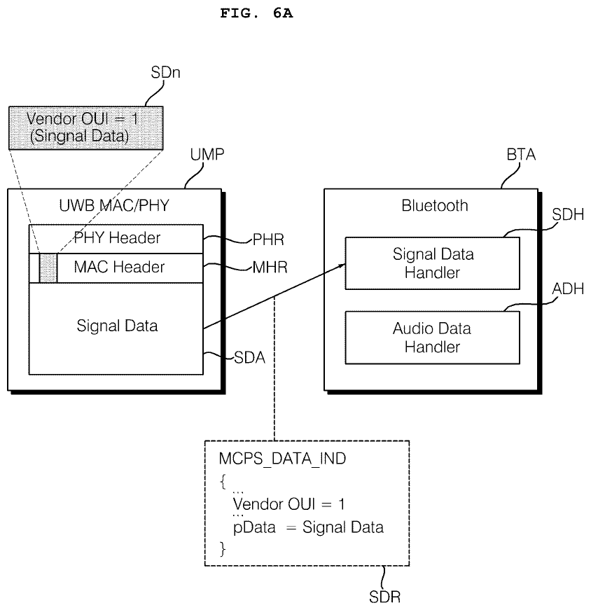

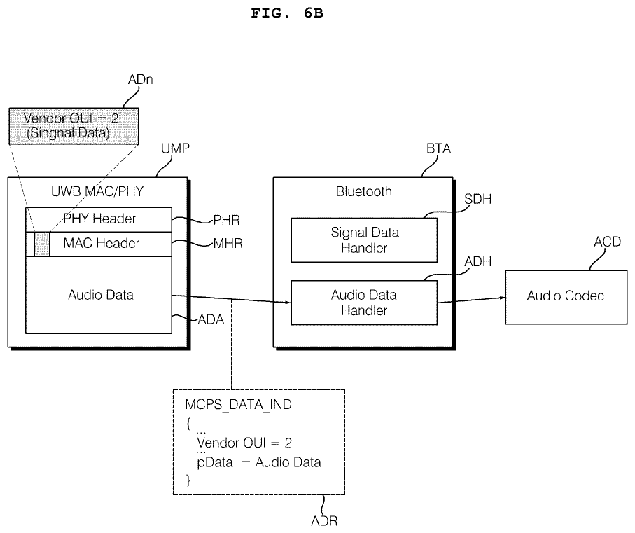

FIGS. 5A and 5B are diagrams for explaining an operation of a wireless audio transmitting device.

Referring to the drawing, the signal data handler SDH in the Bluetooth audio BTA of the wireless audio transmitting device 50 may define an identifier for distinguishing between signal data and audio data by using the Vendor OUI Field of the UWB MAC Header.

FIG. 5A illustrates signal data SDT when the Vendor OUI is ‘1’, and FIG. 5B illustrates audio data ADT when the Vendor OUI is ‘2’.

In particular, the Bluetooth audio BTA of the wireless audio transmitting device 50 may be configured to transmit signal data SDT for codec and QoS configuration used in the UWB audio service.

Meanwhile, when the wireless audio transmitting device 50 is configured to transmit the signal data SDT to the Media access control or physical layer (MAC/PHY) (UMP) of UWB, Vendor OUI, which is UWB MAC Header, may be set to ‘1’ and transmitted.

Meanwhile, in the wireless audio receiving device 100, when codec and QoS configuration are completed, audio data may be transmitted from the audio codec to Bluetooth audio BTA, and Bluetooth Audio BTA may be transmitted to the Media access control or physical layer (MAC/PHY) (UMP) of UWB by setting the Vendor OUI, which is UWB MAC Header, to ‘2’.

In addition, the wireless audio transmitting device 50 may be configured to transmit audio data to the wireless audio receiving device 100 with respect to Media access control or physical layer (MAC/PHY) (UMP) of UWB. Accordingly, even though the wireless environment is complex, it is possible to stably receive audio wirelessly and output sound.

FIGS. 6A and 6B are diagrams for explaining an operation of a wireless audio receiving device.

Referring to the drawing, an identifier for distinguishing between signal data and audio data of Bluetooth audio (BTA) may be defined through the MCPS interface of the wireless audio receiving device 100.

FIG. 6A illustrates signal data SDR when the Vendor OUI is ‘1’, and FIG. 6B illustrates audio data ADR when the Vendor OUI is ‘2’.

When the Media access control or physical layer (MAC/PHY) (UMP) of UWB of the wireless audio receiving device 100 receives data having Vendor OUI, which is the UWB MAC Header, that is set to ‘1’, Bluetooth audio BTA may move to the signal data handler SDH.

In particular, the Bluetooth audio BTA of the wireless audio receiving device 100 may be configured to receive codec and QoS information used in the UWB audio service through a signal data handler SDH, and set information necessary for audio data reception.

Meanwhile, when the codec and QoS configuration for UWB audio service are completed, data whose Vendor OUI, which is the UWB MAC Header, is ‘2’ is received, and Bluetooth audio BTA may move to the audio data handler ADH.

The Bluetooth audio BTA sets a reproducing time for audio data received through an audio data handler (ADH), and the audio data having set reproducing time is transmitted to an audio codec. Accordingly, even though the wireless environment is complex, it is possible to stably receive audio wirelessly and output sound.

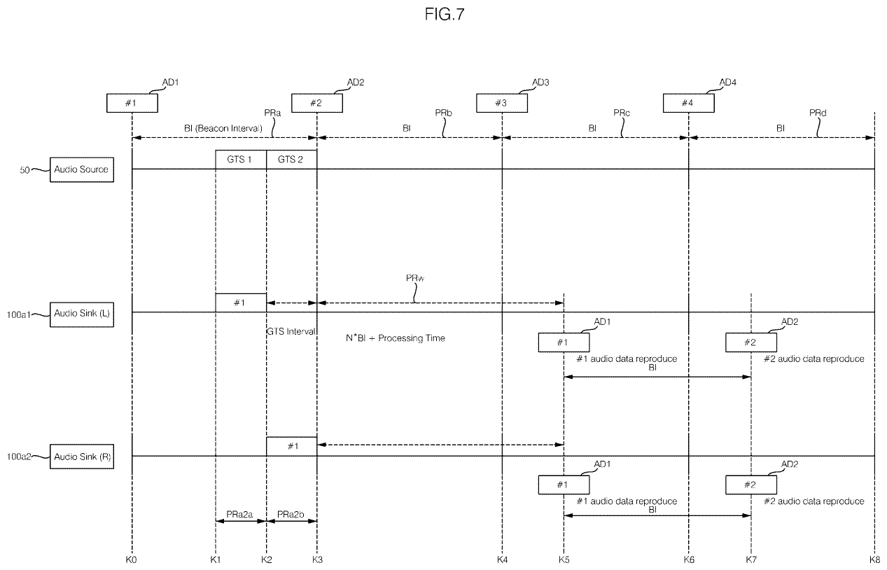

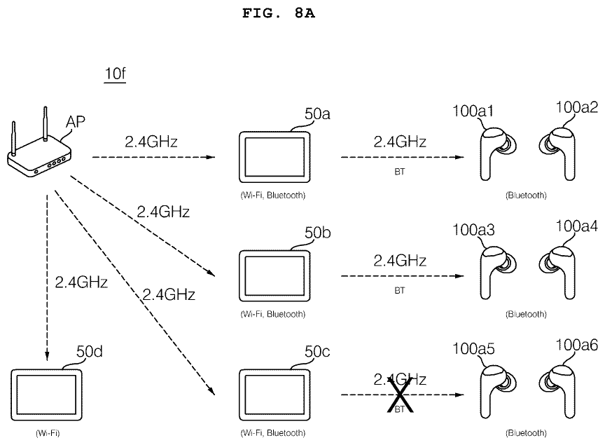

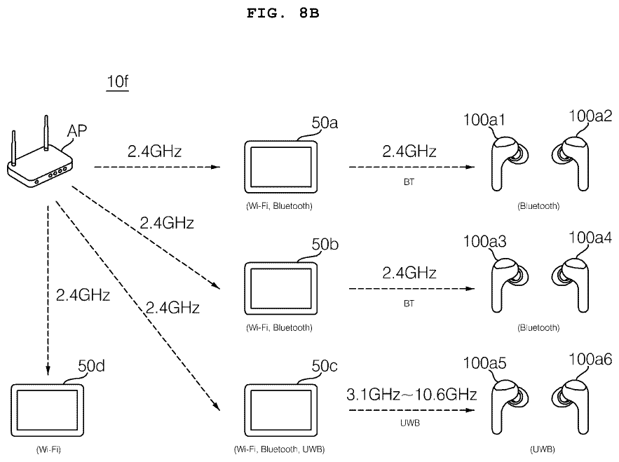

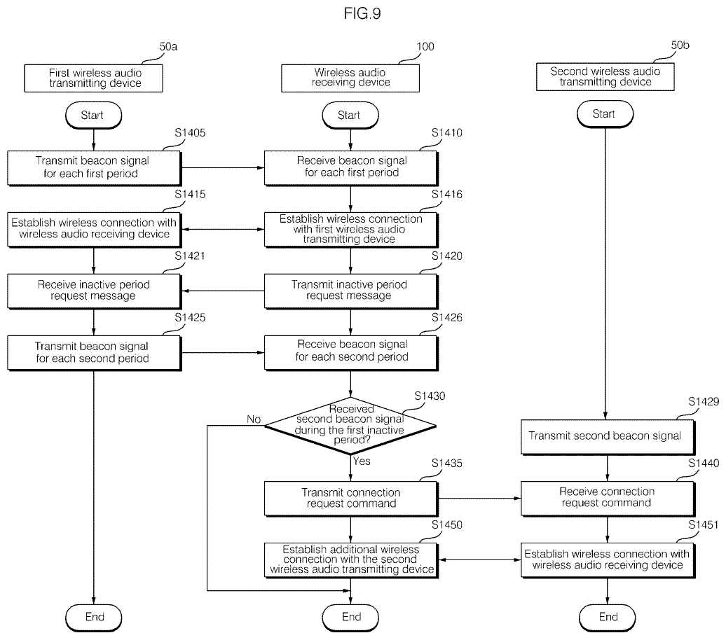

FIG. 7 is a diagram for explaining an UWB audio reproducing time synchronization.

Referring to FIG. 7, the wireless audio transmitting device 50 may sequentially transmit first to fourth audio data AD1 to AD4 to a plurality of wireless audio receiving devices 100a1 and 100a2 respectively.

In particular, the wireless audio transmitting device 50 may sequentially transmit the first to fourth audio data AD1 to AD4 for each channel in a beacon interval.

FIG. 7 illustrates that a first audio data AD1 is generated at time K0, transmitted to a first wireless audio receiving device 100a1 in an interval PRa2a between time K1 and time K2, and transmitted to a second wireless audio receiving device 100a2 in an interval PRa2b between time K2 and time K3.

Meanwhile, the interval PRa2a and the interval PRa2b may be set respectively by a plurality of wireless audio receiving devices 100a1 and 100a2 that receive audio data.

Similarly, at time K3, a second audio data AD2 is generated, and transmitted to the first wireless audio receiving device 100a1 and the second wireless audio receiving device 100a2, within a second beacon interval PRb.

Similarly, at time K4, a third audio data AD3 is generated, and transmitted to the first wireless audio receiving device 100a1 and the second wireless audio receiving device 100a2, within a third beacon interval PRc.

Similarly, at time K6, a fourth audio data AD4 is generated, and transmitted to the first wireless audio receiving device 100a1 and the second wireless audio receiving device 100a2, within a fourth beacon interval PRd.

Meanwhile, in order to synchronize and reproduce the first audio data AD1 received in a first beacon interval PRa in the plurality of wireless audio receiving devices 100a1 and 100a2, it is preferable that it is not reproduced in a second beacon interval PRb, but reproduced at the time K5 in the third beacon interval PRc.

That is, after audio data is reproduced, it is preferable that it is reproduced not in the next beacon interval but in the beacon interval after next.

Meanwhile, it is preferable that the interval PRw from the audio data reception completion time K3 to the reproducing start point K5 is greater than the length of the beacon interval. Accordingly, it is possible to stably synchronize and reproduce audio data.

Meanwhile, after the first audio data AD1 is reproduced at the time K5, it is preferable that the second audio data AD2 is spaced apart by the beacon interval and reproduced at the time K7. Accordingly, it is possible to stably synchronize and reproduce audio data.

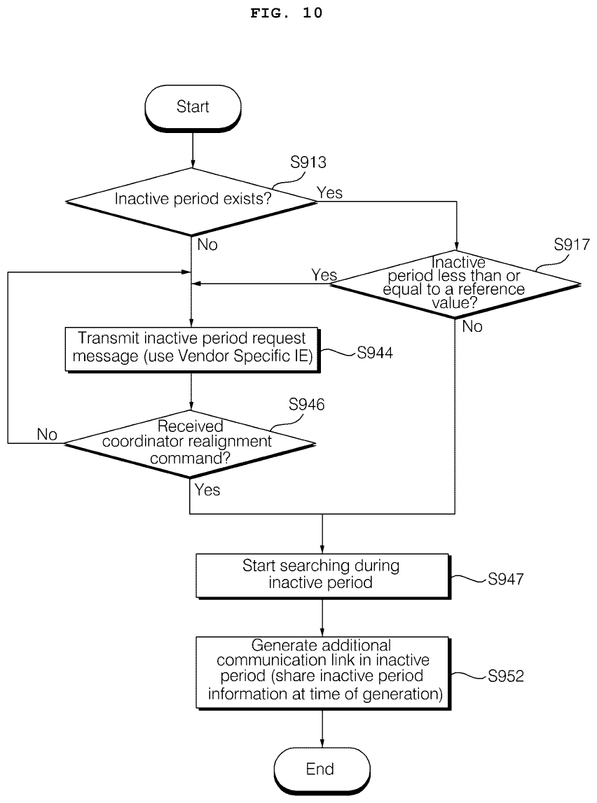

FIGS. 8A and 8B illustrate a wireless audio system 10f including an AP device (AP), a plurality of wireless audio transmitting devices 50a to 50d, and a plurality of wireless audio receiving devices 100a1 to 100a6.

As shown in FIG. 8A, in a complicated wireless environment, between the plurality of wireless audio transmitting devices 50a to 50d and the plurality of wireless audio receiving devices 100a1 to 100a6, when audio is transmitted wirelessly by using Bluetooth communication which is the same first communication standard, audio data transmission becomes impossible due to frequency interference.

FIG. 8A illustrates that audio data transmission is impossible due to frequency interference, between a third wireless audio transmitting device 50c and the plurality of wireless audio receiving devices 100a5 to 100a6.

In order to solve this problem, an embodiment of the present disclosure utilizes the second communication standard having a larger frequency band and a larger bandwidth than the first communication standard. The second communication standard may be UWB.

As shown in FIG. 8B, in a complicated wireless environment, it is preferable that among a plurality of wireless audio transmitting devices 50a to 50d and a plurality of wireless audio receiving devices 100a1 to 100a6, devices excluding the third wireless audio transmitting device 50c and the plurality of wireless audio receiving devices 100a5 to 100a6 use Bluetooth communication which is the first communication standard, and the third wireless audio transmitting device 50c and the plurality of wireless audio receiving devices 100a5 to 100a6 use UWB communication. Accordingly, it is possible to stably transmit and receive wireless audio data even in a complicated wireless environment.

Meanwhile, ultra-wideband (UWB) communication, with its low frequency congestion and strong resistance to interference, may be suitable for use in complex wireless environments.

Accordingly, while UWB communication is typically used for indoor positioning, the present disclosure assumes that UWB communication is utilized for audio services.

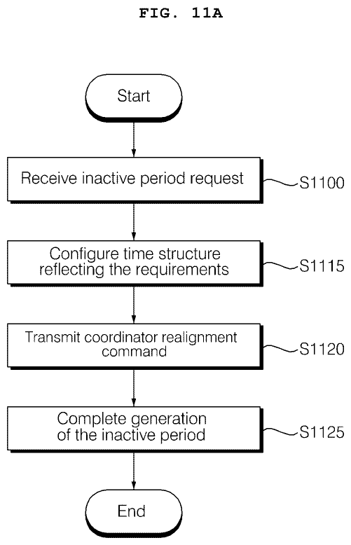

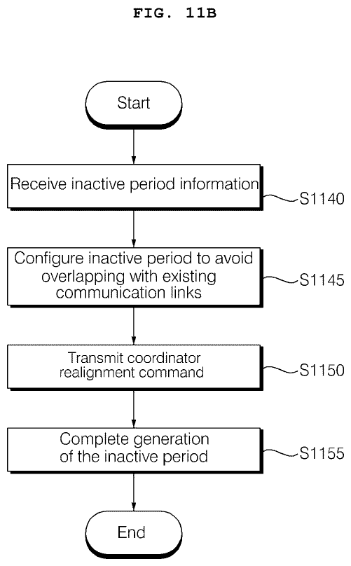

Meanwhile, although UWB communication is provided under standard specifications such as the IEEE 802.15.4, no method for configured to establish a plurality of communication links based on UWB communication has been provided; in the present disclosure, therefore, a method for configured to establish a plurality of communication links based on UWB communication is proposed. The method will be described with reference to FIG. 9 and subsequent figures.

FIG. 9 is an example of a flowchart showing a method of operating a wireless audio output system according to an embodiment of the present disclosure.

Referring to the figure, the first wireless audio transmitting device 50a, which serves as the audio source, is configured to transmit a beacon signal for each first period Pₐ corresponding to the first active period Pₐ S1405.

For example, the PAN coordinator (not shown) within the transceiver 135 of the first wireless audio transmitting device 50a may establish a UWB Personal Area Network (PAN) and transmit a beacon signal for each first period Pₐ corresponding to the first active period Pₐ.

In response to the transmission, the wireless audio receiving device 100, serving as the audio sink, may be configured to receive the beacon signal for each first period Pₐ corresponding to the first active period Pₐ S1410.

Next, the wireless audio receiving device 100 receives the beacon signal for each first period Pₐ corresponding to the first active period Pₐ S1410.

For example, the wireless audio receiving device 100 may perform beacon scanning based on a wake-up signal.

At this time, the wake-up signal may include a power-on signal triggered by a power button, a cradle (not shown) lid-open signal, or a separation signal from the cradle.

The first wireless audio transmitting device 50a performs a wireless connection with the wireless audio receiving device 100 based on a beacon signal through ultra-wideband communication S1415.

In response to the operation above, the wireless audio receiving device 100 performs a wireless connection with the first wireless audio transmitting device 50a based on the beacon signal through ultra-wideband communication S1416.

Meanwhile, the wireless audio receiving device 100, which is wirelessly connected via ultra-wideband communication, is configured to transmit an inactive period request message or a new beacon interval request message S1420.

For example, the wireless audio receiving device 100 is configured to transmit an inactive period request message or a new beacon interval request message by including the message in a portion of the MAC header.

Next, the first wireless audio transmitting device 50a receive an inactive period request message or a new beacon interval request message from the wireless audio receiving device 100 S1421.

Subsequently, the Personal Area Network (PAN) coordinator (not shown) within the transceiver 135 of the first wireless audio transmitting device 50a is configured to transmit a beacon signal for each period P_{c} corresponding to the first active period Pₐ and the first inactive period P_{b} by adding the first inactive period P_{b} S1425.

In response to the operation above, the transceiver 135 within the wireless audio receiving device 100 receives a beacon signal for each period P_{c} corresponding to the first active period Pₐ and the first inactive period P_{b} S1426.

Meanwhile, the transceiver 135 within the wireless audio receiving device 100 may search for additional devices during the first inactive period P_{b}.

Meanwhile, the PAN coordinator (not shown) within the transceiver 135 of the second wireless audio transmitting device 50b may be configured to transmit a second beacon signal S1429.

Next, if the second beacon signal is received from the second wireless audio transmitting device 50b S1430 during the first inactive period P_{b}, the transceiver 135 within the wireless audio receiving device 100 is configured to transmit an association request command to the second wireless audio transmitting device 50b S1435.

In response to the operation above, the transceiver 135 within the second wireless audio transmitting device 50b receives a connection request command S1440.

Meanwhile, while being wirelessly connected with the first wireless audio transmitting device 50a, the transceiver 135 within the wireless audio receiving device 100 performs a wireless connection with the second wireless audio transmitting device 50b based on the second beacon signal or the connection request command through ultra-wideband communication S1450.

In response to the operation above, the transceiver 135 within the second wireless audio transmitting device 50b performs a wireless connection with the wireless audio receiving device 100 based on the second beacon signal or the connection request command through ultra-wideband communication S1451. Accordingly, the wireless audio receiving device 100 may establish a plurality of communication links based on ultra-wideband communication.

Meanwhile, the transceiver 135 within the first wireless audio transmitting device 50a according to one embodiment of the present disclosure is configured to transmit a beacon signal for each period corresponding to the first active period Pₐ, receive an inactive period request message or a new beacon interval request message from the wireless audio receiving device 100 while being wirelessly connected with the wireless audio receiving device 100, and is configured to transmit a beacon signal for each period P_{c} corresponding to the first active period Pₐ and the first inactive period P_{b} in response to the inactive period request message or the new beacon interval request message. Accordingly, a plurality of communication links based on ultra-wideband communication can be established.

Meanwhile, the transceiver 135 within the second wireless audio transmitting device 50b according to one embodiment of the present disclosure is configured to transmit a beacon signal for each period corresponding to the first active period Pₐ, receive an inactive period request message or a new beacon interval request message from the wireless audio receiving device 100 while being wirelessly connected with the wireless audio receiving device 100, and is configured to transmit a beacon signal for each period P_{c} corresponding to the first active period Pₐ and the first inactive period P_{b} in response to the inactive period request message or the new beacon interval request message. Accordingly, a plurality of communication links based on ultra-wideband communication can be established.

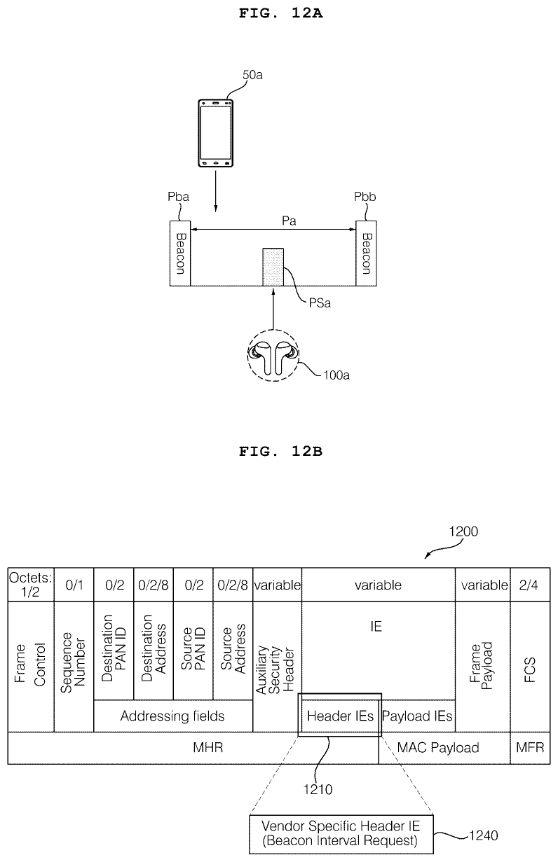

FIG. 10 is a flowchart illustrating detailed operations of the wireless audio receiving device 100 of FIG. 9.

Referring to the figure, the transceiver 135 within the wireless audio receiving device 100 periodically receives the beacon signal from the first wireless audio transmitting device 50a and determines whether an inactive period exists based on the periodically received beacon signal S913; if no inactive period is detected, the transceiver 135 may be configured to transmit an inactive period request message or a new beacon interval request message to the first wireless audio transmitting device 50a S944.

Specifically, the transceiver 135 within the wireless audio receiving device 100 may be configured to receive a beacon signal from the first wireless audio transmitting device 50a for each period corresponding to the first active period Pₐ and, while being wirelessly connected with the first wireless audio transmitting device 50a, may be configured to transmit the inactive period request message or the new beacon interval request message to the first wireless audio transmitting device 50a.

Next, after transmitting the inactive period request message or the new beacon interval request message, the transceiver 135 within the wireless audio receiving device 100 determines whether a coordinator realignment command is received within a specified time; if the command is received, the transceiver 135 may perform an additional device search during the first inactive period P_{b} S947.

Specifically, the transceiver 135 within the wireless audio receiving device 100, while being wirelessly connected with the first wireless audio transmitting device 50a, may be configured to transmit the inactive period request message or the new beacon interval request message to the first wireless audio transmitting device 50a and, in response to a coordinator realignment command being received within a specified time, may perform an additional device search during the first inactive period P_{b}.

Meanwhile, in the S913 step, if an inactive period exists, the transceiver 135 within the wireless audio receiving device 100 determines whether the inactive period is less than or equal to a reference value S917.

For example, if the inactive period is less than or equal to the reference value, the S944 step is performed, and the transceiver 135 within the wireless audio receiving device 100 may be configured to transmit an inactive period request message or a new beacon interval request message to the first wireless audio transmitting device 50a.

In other words, if no inactive period exists or if the inactive period is less than or equal to the reference value during the period P_{c} of a beacon signal received from the first wireless audio transmitting device 50a, the transceiver 135 within the wireless audio receiving device 100, while being wirelessly connected with the first wireless audio transmitting device 50a, may be configured to transmit an inactive period request message or a new beacon interval request message for configuring the inactive period to the first wireless audio transmitting device 50a. Accordingly, a beacon signal may be received for each period P_{c} corresponding to the first active period Pₐ and the first inactive period P_{b}.

Meanwhile, if the inactive period exceeds the reference value, the transceiver 135 within the wireless audio receiving device 100 may perform the S947 step.

Meanwhile, if the transceiver 135 within the wireless audio receiving device 100 searches for additional devices and receives a second beacon signal from the second wireless audio transmitting device 50b during the first inactive period P_{b}, the transceiver 135 may perform an additional wireless connection with the second wireless audio transmitting device 50b based on the second beacon signal S952 through ultra-wideband communication while being wirelessly connected with the first wireless audio transmitting device 50a. Accordingly, a plurality of communication links based on ultra-wideband communication can be established.

Meanwhile, if the transceiver 135 within the wireless audio receiving device 100 searches for additional devices and receives a second beacon signal from the second wireless audio transmitting device 50b during the first inactive period P_{b}, the transceiver 135 may be configured to transmit a connection request command including period-related information to the second wireless audio transmitting device 50b. Accordingly, the second beacon signal synchronized with a beacon signal from the first wireless audio transmitting device 50a may be received.

FIG. 11A is a flowchart illustrating detailed operations of the first wireless audio transmitting device 50a of FIG. 9.

Referring to the figure, the transceiver 135 within the first wireless audio transmitting device 50a is configured to transmit a beacon signal for each period corresponding to the first active period Pₐ.

Additionally, the transceiver 135 within the first wireless audio transmitting device 50a, while being wirelessly connected with the wireless audio receiving device 100, receive an inactive period request message or a new beacon interval request message from the wireless audio receiving device 100 S1100.

In response to the operation above, the PAN coordinator (not shown) within the transceiver 135 of the first wireless audio transmitting device 50a configures a time structure reflecting the inactive period request message or the new beacon interval request message S1115.

For example, the PAN coordinator (not shown) within the transceiver 135 of the first wireless audio transmitting device 50a may add the first inactive period P_{b} to the first active period Pₐ.

As another example, if the first inactive period P_{b} exists but is less than or equal to the reference value, the PAN coordinator (not shown) within the transceiver 135 of the first wireless audio transmitting device 50a may generate a first inactive period P_{b} that exceeds the reference value.

Next, the PAN coordinator (not shown) within the transceiver 135 of the first wireless audio transmitting device 50a is configured to transmit a coordinator realignment command based on the addition of the first inactive period P_{b} S1120.

Subsequently, the PAN coordinator (not shown) within the transceiver 135 of the first wireless audio transmitting device 50a completes the creation of the inactive period S1125.

Accordingly, the PAN coordinator (not shown) within the transceiver 135 of the first wireless audio transmitting device 50a is configured to transmit a beacon signal for each period P_{c} corresponding to the first active period Pₐ and the first inactive period P_{b} by adding the first inactive period P_{b} to the first active period Pₐ.

Alternatively, if the first inactive period P_{b} exists but is less than or equal to the reference value, the PAN coordinator (not shown) within the transceiver 135 of the first wireless audio transmitting device 50a may adjust the first inactive period to exceed the reference value and transmit a beacon signal for each period P_{c} corresponding to the first active period Pₐ and the first inactive period P_{b}.

FIG. 11B is a flowchart illustrating detailed operations of the first wireless audio transmitting device 50b of FIG. 9.

Referring to the figure, the transceiver 135 within the second wireless audio transmitting device 50b receives a connection request command, which includes period-related information from the wireless audio receiving device 100 S1140.

The period-related information may include the period P_{c} of the beacon signal received by the wireless audio receiving device 100 from the first wireless audio transmitting device 50a, the first inactive period P_{b} of the beacon signal, or the first active period Pₐ of the beacon signal.

Additionally, the transceiver 135 within the second wireless audio transmitting device 50b may configure the second active period of the second wireless audio transmitting device 50b to avoid overlapping with the existing communication link between the wireless audio receiving device 100 and the first wireless audio transmitting device 50a S1145.

For example, the PAN coordinator (not shown) within the transceiver 135 of the second wireless audio transmitting device 50b may add a second inactive period Pₛ to the second active period P_{d}.

As another example, if the second inactive period Pₛ exists but is less than or equal to the reference value, the PAN coordinator (not shown) within the transceiver 135 of the second wireless audio transmitting device 50b may generate a second inactive period Pₛ that exceeds the reference value.

Next, the PAN coordinator (not shown) within the transceiver 135 of the second wireless audio transmitting device 50b is configured to transmit a coordinator realignment command based on the addition of the second inactive period Pₛ S1150.

Subsequently, the PAN coordinator (not shown) within the transceiver 135 of the second wireless audio transmitting device 50b completes the creation of the inactive period $1155.

Accordingly, the PAN coordinator (not shown) within the transceiver 135 of the second wireless audio transmitting device 50b is configured to transmit a beacon signal for each period P_{c} corresponding to the second active period P_{d} and the second inactive period Pₛ by adding the second inactive period P_{∈} to the second active period P_{d}. this time, it is preferable that the period should be the same as the period P_{c}, which corresponds to the first active period Pₐ and the first inactive period P_{b}.

Alternatively, if the second inactive period Pₛ exists but is less than or equal to the reference value, the PAN coordinator (not shown) within the transceiver 135 of the second wireless audio transmitting device 50b may adjust the second inactive period to exceed the reference value and transmit a beacon signal for each period P_{c} corresponding to the second active period P_{d} and the second inactive period Pₛ.

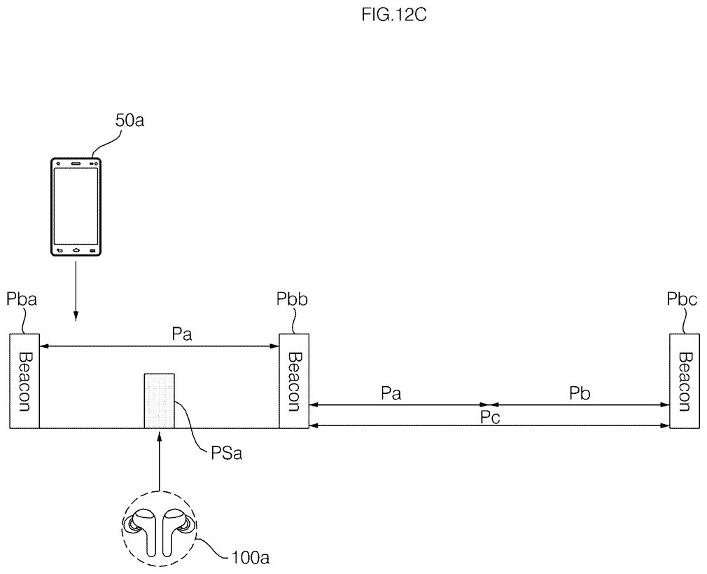

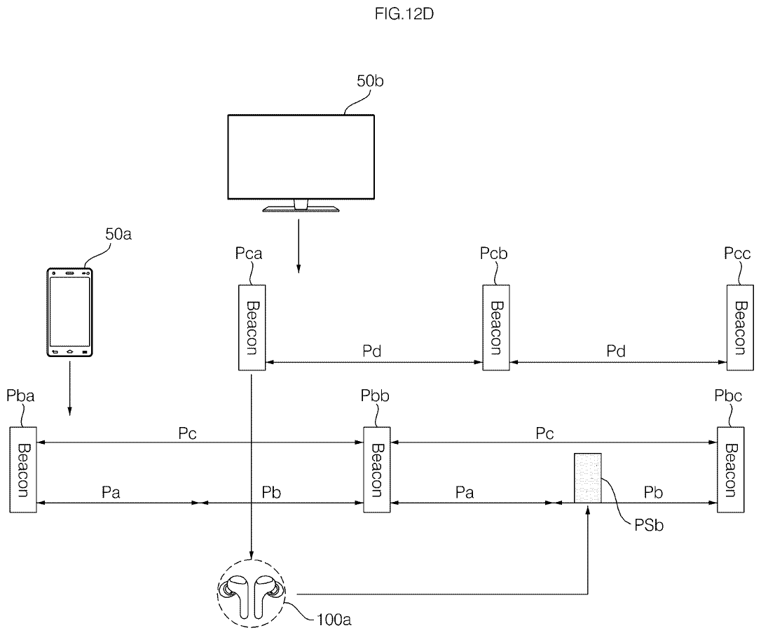

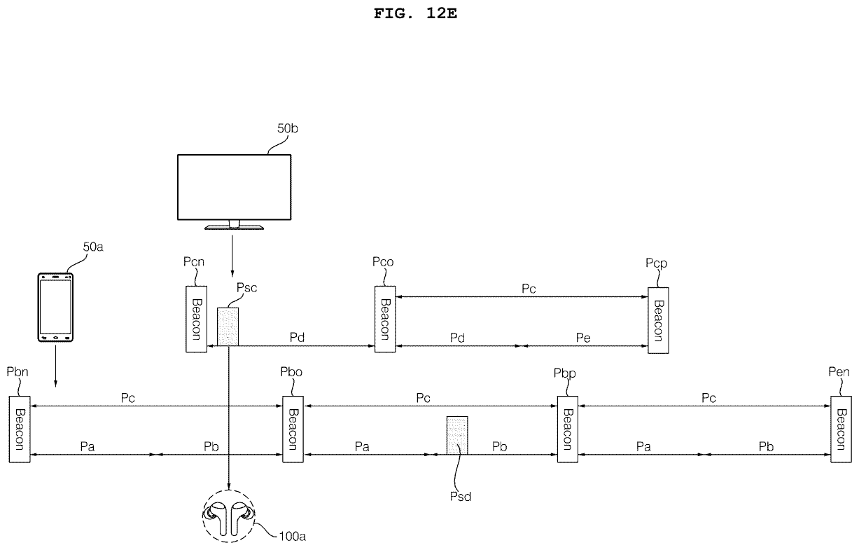

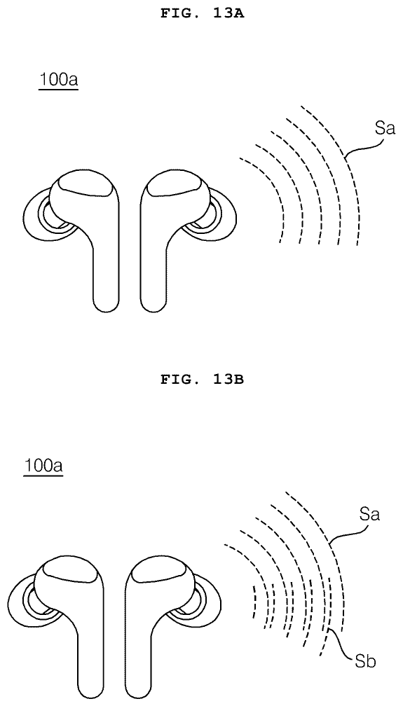

FIGS. 12a to 13b are diagrams referred to in description of FIGS. 9 to 11b.

First, FIG. 12A illustrates a case in which the first wireless audio transmitting device 50a, serving as the audio source, is configured to transmit beacon signals Pba, Pbb for each first period Pₐ corresponding to the first active period Pₐ.

In response to the operation above, the wireless audio receiving device 100a, serving as the audio sink, receives the beacon signals Pba, Pbb for each first period Pₐ corresponding to the first active period Pₐ.

Meanwhile, the wireless audio receiving device 100a, which is wirelessly connected based on ultra-wideband communication, may be configured to transmit an inactive period request message or a new beacon interval request message PSa.

In particular, the wireless audio receiving device 100a may be configured to transmit the inactive period request message or the new beacon interval request message PSa during the first active period Pₐ.

FIG. 12B illustrates a case in which an inactive period request message or a new beacon interval request message is included in a portion of the MAC header 1200.

Specifically, a Vendor Specific IE 1240 may be added to the Header IEs 1210, which is a part of the MAC header 1200, and the Vendor Specific IE 1240 may include an inactive period request message or a new beacon interval request message.

Accordingly, the wireless audio receiving device 100a may be configured to transmit the inactive period request message or the new beacon interval request message by including them in a portion of the MAC header.

FIG. 12C illustrates a case in which the first wireless audio transmitting device 50a adds the first inactive period P_{b} and is configured to transmit beacon signal Pbb, Pbc for each period P_{c} corresponding to the first active period Pₐ and the first inactive period P_{b}.

The figure illustrates a case in which beacon signals Pba, Pbb are transmitted for each first period Pₐ corresponding to the first active period Pₐ, and after an inactive period request message or a new beacon interval request message PSa is received, the first inactive period P_{b} is added, and beacon signals Pbb, Pbc are transmitted for each period P_{c} corresponding to the first active period Pₐ and the first inactive period P_{b}.

Meanwhile, the transceiver 135 within the first wireless audio transmitting device 50a may be configured to transmit a coordinator realignment command in response to the inactive period request message or the new beacon interval request message PSa and, after transmitting the coordinator realignment command, transmit beacon signals Pbb, Pbc for each period P_{c} corresponding to the first active period Pₐ and the first inactive period P_{b}. Accordingly, a plurality of communication links based on ultra-wideband communication can be established.

According to the figure, the transceiver 135 within the wireless audio receiving device 100a receives beacon signals Pba, Pbb for each first period Pₐcorresponding to the first active period Pₐ before transmitting the inactive period request message or the new beacon interval request message PSa and after transmitting the inactive period request message or the new beacon interval request message PSa, receives beacon signals Pbb, Pbc for each period P_{c}, which corresponds to the first active period Pₐ and the first inactive period P_{b}, with P_{c} being greater than the first period Pₐ.

FIG. 12D illustrates a case in which the transceiver 135 within the wireless audio receiving device 100a searches for additional devices during the first inactive period P_{b} and receives a second beacon signal from the second wireless audio transmitting device 50b.

Referring to the figure, the transceiver 135 within the wireless audio receiving device 100a may search for additional devices during the first inactive period P_{b} and receive a second beacon signal Pca from the second wireless audio transmitting device 50b.

The figure illustrates a case in which the second wireless audio transmitting device 50b is configured to transmit second beacon signals Pca, Pcb, Pcc for each period P_{d} corresponding to the second active period P_{d}.

Meanwhile, if the transceiver 135 within the wireless audio receiving device 100a searches for additional devices and receives a second beacon signal Pca, Pcb from the second wireless audio transmitting device 50b during the first inactive period P_{b}, the transceiver 135 may be configured to transmit a connection request command PSb including period P_{c}-related information to the second wireless audio transmitting device 50b.

The period P_{c}-related information may include the period P_{c} of the beacon signal received by the wireless audio receiving device 100 from the first wireless audio transmitting device 50a, the first inactive period P_{b} of the beacon signal, or the first active period Pₐ of the beacon signal.

Meanwhile, during the additional device search within the first inactive period P_{b}, the period P_{d} of the second beacon signal received from the second wireless audio transmitting device 50b may be shorter than the period P_{c}, which corresponds to the first active period Pₐ and the first inactive period P_{b}.

FIG. 12E illustrates a case in which the second wireless audio transmitting device 50b adds a second inactive period Pₛ and is configured to transmit second beacon signals Pco, Pcp for each period P_{c} corresponding to the second active period P_{d} and the second inactive period Pₛ.

Referring to the figure, the second wireless audio transmitting device 50b, based on the connection request command Psd, may add a second inactive period Pₛ and transmit second beacon signals Pco, Pcp for each period P_{c} corresponding to the second active period P_{d} and the second inactive period Pₛ.

Meanwhile, the transceiver 135 of the second wireless audio transmitting device 50b may be configured to transmit a coordinator realignment command Psc in response to the addition of the second inactive period Pₛ and, after transmitting the coordinator realignment command, may be configured to transmit second beacon signals Pco, Pcp for each period P_{c} corresponding to the second active period P and the second inactive period Pₛ. Accordingly, a plurality of communication links based on ultra-wideband communication can be established.

According to the figure, the transceiver 135 within the wireless audio receiving device 100a receives second beacon signals Pcn, Pco for each period P_{d}corresponding to the second active period P_{d} before the addition of the second inactive period Pₛ and after the addition of the second inactive period Pₛ, receives second beacon signals Pcn, Pco for each period P_{c} corresponding to the second active period P_{d}, which is greater than the period P_{d}, and the second inactive period Pₛ. Accordingly, second beacon signals synchronized with the beacon signals from the first wireless audio transmitting device 50a may be received.

Meanwhile, comparing FIG. 12A and FIG. 12E, the period P_{c} of the beacon signal from the first wireless audio transmitting device 50a wirelessly connected with the first wireless audio transmitting device 50a and the second wireless audio transmitting device 50b is greater than the period Pₐ of the beacon signal from the first wireless audio transmitting device 50a wirelessly connected with the first wireless audio transmitting device 50a. Accordingly, a plurality of communication links based on ultra-wideband communication can be established.

In other words, the transceiver 135 within the wireless audio receiving device 100a may be configured to receive, from the first wireless audio transmitting device 50a, a beacon signal with a period increasing in accordance with the number of communication links based on ultra-wideband communication.

FIG. 13A illustrates a case in which a first sound Sa is output from the wireless audio receiving device 100a while the first wireless audio transmitting device 50a is wirelessly connected with the wireless audio receiving device 100a based on ultra-wideband communication.

Referring to the figure, the wireless audio receiving device 100a may be configured to receive a first audio signal from the first wireless audio transmitting device 50a, and the sound output device 160 may be configured to output a first sound Sa based on the first audio signal from the first wireless audio transmitting device 50a while being wirelessly connected with the first wireless audio transmitting device 50a.

FIG. 13B illustrates a case in which, while the wireless audio receiving device 100a is wirelessly connected with the first wireless audio transmitting device 50a, the second wireless audio transmitting device 50b is additionally connected wirelessly with the wireless audio receiving device 100a based on ultra-wideband communication, allowing the wireless audio receiving device 100a to output the first sound Sa and the second sound Sb together.

Referring to the figure, the wireless audio receiving device 100a may be configured to receive a first audio signal from the first wireless audio transmitting device 50a and a second audio signal from the second wireless audio transmitting device 50b; and the sound output device 160 may be configured to output the first sound Sa based on the first audio signal from the first wireless audio transmitting device 50a and the second sound Sb based on the second audio signal from the second wireless audio transmitting device 50b together.

Accordingly, a plurality of communication links based on ultra-wideband communication may be formed, enabling a plurality of sounds to be output together.

Meanwhile, the first sound Sa may be a music sound, and the second sound Sb may be a call sound. Accordingly, call content may be output during music playback.

As another example, the first sound Sa may be a stereo channel sound, and the second sound Sb may be a bass sound. Accordingly, sounds from various channels may be output together.

Although the present disclosure has been described with reference to specific embodiments shown in the drawings, it is apparent to those skilled in the art that the present description is not limited to those exemplary embodiments and is embodied in many forms without departing from the scope of the present disclosure, which is described in the following claims. These modifications should not be individually understood from the technical spirit or scope of the present disclosure.

1. A wireless audio receiving device comprising:
a transceiver configured to establish a wireless connection with a first wireless audio transmitting device and receive an audio signal from the first wireless audio transmitting device connected wirelessly through ultra-wideband communication; and
a sound output device configured to output sound corresponding to the audio signal received from the transceiver,
wherein the transceiver is configured to receive a beacon signal from the first wireless audio transmitting device for each period corresponding to a first active period and a first inactive period,
search for additional devices during the first inactive period, transmit a connection request command to a second wireless audio transmitting device in response to a second beacon signal being received from the second wireless audio transmitting device, and
establish an additional wireless connection with the second wireless audio transmitting device based on the connection request command while being wirelessly connected with the first wireless audio transmitting device.

2. The device of claim 1, wherein the transceiver is configured to receive a beacon signal for each period corresponding to the first active period from the first wireless audio transmitting device and
transmit an inactive period request message or a new beacon interval request message to the first wireless audio transmitting device while being wirelessly connected with the first wireless audio transmitting device.

3. The device of claim 1, wherein the transceiver is configured to transmit an inactive period request message or a new beacon interval request message to the first wireless audio transmitting device while being wirelessly connected with the first wireless audio transmitting device and,
perform an additional device search during the first inactive period in response to a coordinator realignment command being received within a predetermine time.

4. The device of claim 1, wherein, in case in which an inactive period does not exist or the inactive period is shorter than a reference value during the period of a beacon signal received from the first wireless audio transmitting device, the transceiver is configured to transmit an inactive period request message for configuring the inactive period or a new beacon interval request message to the first wireless audio transmitting device while being wirelessly connected with the first wireless audio transmitting device.

5. The device of claim 1, wherein, in response to a second beacon signal being received from a second wireless audio transmitting device from an additional device search during the first inactive period, the transceiver is configured to transmit a connection request command including information related to the period to the second wireless audio transmitting device.

6. The device of claim 1, wherein, after establishing a wireless connection with the second wireless audio transmitting device, the transceiver is configured to receive a second beacon signal for each period from the second wireless audio transmitting device.

7. The device of claim 1, wherein, after the transceiver is configured to establish a wireless connection with the second wireless audio transmitting device, the period of a second beacon signal from the second wireless audio transmitting device is adjusted to match the period of a beacon signal from the first wireless audio transmitting device.

8. The device of claim 1, wherein, during an additional device search within the first inactive period, the period of a beacon signal received from the second wireless transmitting device is shorter than the period corresponding to the first active period and the first inactive period.

9. The device of claim 1, wherein, during the first inactive period, the transceiver is configured to receive a second beacon signal from the second wireless audio transmitting device.

10. The device of claim 9, wherein the transceiver is configured to receive the second beacon signal for each period including a second active period and a second inactive period.

11. The device of claim 1, wherein the sound output device is configured to:
output a first sound based on a first audio signal from the first wireless audio transmitting device while being wirelessly connected with the first wireless audio transmitting device and
output a first sound based on a first audio signal from the first wireless audio transmitting device and a second sound based on a second audio signal from the second wireless audio transmitting device together while being wirelessly connected with the second wireless audio transmitting device.

12. A wireless audio receiving device comprising:
a transceiver configured to wirelessly connect to a first wireless audio transmitting device and receive an audio signal from the first wireless audio transmitting device connected wirelessly through ultra-wideband communication; and
a sound output device configured to output sound corresponding to the audio signal received from the transceiver,
wherein the transceiver is configured to establish an additional wireless connection with a second wireless audio transmitting device while performing an additional wireless connection with the first wireless audio transmitting device, and
the period of a beacon signal from the first wireless audio transmitting device performing a wireless connection with the first wireless audio transmitting device and the second wireless audio transmitting device is greater than the period of a beacon signal from the first wireless audio transmitting device performing a wireless connection with the first wireless audio transmitting device.

13. The device of claim 12, wherein the transceiver is configured to:
receive a beacon signal for each period corresponding to the first active period from the first wireless audio transmitting device while being wirelessly connected with the first wireless audio transmitting device and
receive a beacon signal from the first wireless audio transmitting device for each period corresponding to the first active period and the first inactive period while being wirelessly connected with the first wireless audio transmitting device and the second wireless audio transmitting device.

14. The device of claim 13, wherein the transceiver is configured to receive a beacon signal from the second wireless audio transmitting device for each period corresponding to the first active period and the first inactive period while being wirelessly connected with the first wireless audio transmitting device and the second wireless audio transmitting device.

15. A wireless audio transmitting device comprising:
a transceiver configured to establish a wireless connection with a wireless audio receiving device and transmit an audio signal to the wireless audio receiving device connected wirelessly through ultra-wideband communication,
wherein the transceiver is configured to:
transmit a beacon signal for each period corresponding to the first active period,
receive an inactive period request message or a new beacon interval request message from the wireless audio receiving device while being wirelessly connected with the wireless audio receiving device, and
transmit a beacon signal for each period corresponding to the first active period and the first inactive period in response to the inactive period request message or the new beacon interval request message.

16. The device of claim 15, wherein the transceiver is configured to transmit a coordinator realignment command in response to the inactive period request message or the new beacon interval request message and transmit a beacon signal for each period corresponding to the first active period and the first inactive period after transmitting the coordinator realignment command.

17. A wireless audio output system comprising:
a wireless audio transmitting device; and
a wireless audio receiving device,
wherein the wireless audio receiving device comprises:
a transceiver configured to establish a wireless connection with a first wireless audio transmitting device and receive an audio signal from the first wireless audio transmitting device connected wirelessly through ultra-wideband communication; and
a sound output device configured to output sound corresponding to the audio signal received from the transceiver,
wherein the transceiver is configured to receive a beacon signal from the first wireless audio transmitting device for each period corresponding to a first active period and a first inactive period,
search for additional devices during the first inactive period, transmit a connection request command to a second wireless audio transmitting device in response to a second beacon signal being received from the second wireless audio transmitting device, and
establish an additional wireless connection with the second wireless audio transmitting device based on the connection request command while being wirelessly connected with the first wireless audio transmitting device.

18. The system of claim 17, wherein the wireless audio transmitting device includes:
a second transceiver configured to establish a wireless connection with a wireless audio receiving device and transmit an audio signal to the wireless audio receiving device connected wirelessly through ultra-wideband communication,
wherein the second transceiver is configured to:
transmit a beacon signal for each period corresponding to the first active period,
receive an inactive period request message or a new beacon interval request message from the wireless audio receiving device while being wirelessly connected with the wireless audio receiving device, and
transmit a beacon signal for each period corresponding to the first active period and the first inactive period in response to the inactive period request message or the new beacon interval request message.

19. The system of claim 17, wherein the wireless audio receiving device is configured to receive a beacon signal for each period corresponding to the first active period from the first wireless audio transmitting device and
transmit an inactive period request message or a new beacon interval request message to the first wireless audio transmitting device while being wirelessly connected with the first wireless audio transmitting device.

20. The system of claim 18, wherein the wireless audio transmitting device is configured to transmit a coordinator realignment command in response to the inactive period request message or the new beacon interval request message and transmit a beacon signal for each period corresponding to the first active period and the first inactive period after transmitting the coordinator realignment command.
